(19) United States
(12) Patent Application Publication
(10) Pub. No.: US 2025/0187353 A1
(43) Pub. Date: Jun. 12, 2025

(54) PRINTING APPARATUS, CONTROL METHOD THEREOF, AND STORAGE MEDIUM

(71) Applicant: CANON KABUSHIKI KAISHA, Tokyo (JP)

(72) Inventor: Yuki Shiba, Kanagawa (JP)

(21) Appl. No.: 18/967,812

(22) Filed: Dec. 4, 2024

(30) Foreign Application Priority Data
Dec. 8, 2023 (JP) 2023-207382

(51) Int. Cl. B41J 11/46; B41J 3/407; B41J 11/00

(52) U.S. Cl. CPC B41J 11/46; B41J 3/4075; B41J 11/007

(57) ABSTRACT

The printing apparatus performing printing while conveying a printing medium has: a detection unit configured to detect a mark on the printing medium for determining start timing to perform the printing or start timing to perform post printing of the printing; a determination unit configured to determine whether or not the detection unit has succeeded in detecting the mark; and a control unit configured to control start timing of the printing or the post printing thereof. Then, the control unit: determines, in a case where the detection has succeeded, the above-described start timing based on results of the detection; and determines, in a case where the detection has failed, the above-described start timing in accordance with a mark detected before the failure.

### BACKGROUND

### Field

The present disclosure relates to an operation control technique using a timing mark in a printing system.

### Description of the Related Art

Conventionally, in a digital printing system, operation control using a timing mark is performed in a case where a pictorial pattern is printed after a color of the background is printed, in a case where a sheet on which a pictorial pattern is printed is modified, and the like. Japanese Patent Laid-Open No. 2020-138409 has disclosed a control method that enables printing or modification even in a case where the position of a timing mark fluctuates. The contents are that the start timing of printing or modification is determined based on the statistical information including one or more pieces of data based on the number of pulses of the pulse signal output during the period of time from the detection of the timing mark to the detection of the next timing mark.

With the technique of Japanese Patent Laid-Open No. 2020-138409 described above, in determining the start timing of the processing in the post stage, such as printing and modification, it is necessary to both detect the timing mark and obtain the number of pulses of the pulse signal. Because of that, there is such a problem that it is not possible to determine the start timing of the processing in the post stage in a case where the timing mark cannot be detected.

### SUMMARY

The present disclosure has been made in order to solve the above-described problem and an object is to make it possible to appropriately perform the processing in the post stage, such as printing and modification, even in a case where the timing mark cannot be detected.

The printing apparatus according to the present disclosure is a printing apparatus performing printing while conveying a printing medium, the printing apparatus including: a detection unit configured to detect a mark on the printing medium for determining start timing to perform the printing or start timing to perform post printing of the printing; a determination unit configured to determine whether or not the detection unit has succeeded in detecting the mark; and a control unit configured to control start timing of the printing or the post printing, wherein the control unit: determines, in a case where the detection has succeeded, the start timing based on results of the detection; and determines, in a case where the detection has failed, the start timing in accordance with a mark detected before the failure. Furthermore, the printing apparatus according to the present disclosure is a printing apparatus performing printing while conveying a printing medium, the printing apparatus including: a detection unit configured to detect marks on the printing medium aligned with predetermined distance in a direction of the conveying; and a control unit configured to control the printing or performing post printing of the printing based on results of the detection in a case where the detection unit detect the marks and control the printing or performing post printing of the printing based on a predetermined timing.

Further features of the present disclosure will become apparent from the following description of exemplary embodiments with reference to the attached drawings.

### BRIEF DESCRIPTION OF THE DRAWINGS

FIG. 1 is a diagram showing a configuration example of a printing system according to a first embodiment;

FIG. 2 is a function block diagram showing a software configuration of a control PC according to the first embodiment;

FIG. 3 is a flowchart showing a flow of printing control in the printing system according to the first embodiment;

FIG. 4 is one example of a case where a timing mark is formed appropriately and the detection thereof has succeeded;

FIG. 5A and FIG. 5B are comparative examples of the prior art and the first embodiment;

FIG. 6 is a diagram showing a configuration example of a printing system according to a second embodiment;

FIG. 7 is a function block diagram showing a software configuration of a control PC according to the second embodiment;

FIG. 8 is a flowchart showing a flow of printing and modification control in the printing system according to the second embodiment; and

FIG. 9A and FIG. 9B are comparative examples of the prior art and the second embodiment.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

In the present specification, explanation is given by taking a printing system as an example, which forms an image by conveying a continuous sheet at a predetermined speed in a direction intersecting a direction in which printing elements are arrayed by using a print head (line head) of each ink color, in which a plurality of printing elements corresponding to the width of the continuous sheet is arrayed. Further, explanation is given by taking roll sheet as a continuous sheet, but the continuous sheet may be a material other than paper, for example, such as a film. Furthermore, the printing system may be one that forms an image by taking a cut sheet of a predetermined size, such as A4, as a target.

### First Embodiment

### Outline of Printing System Configuration

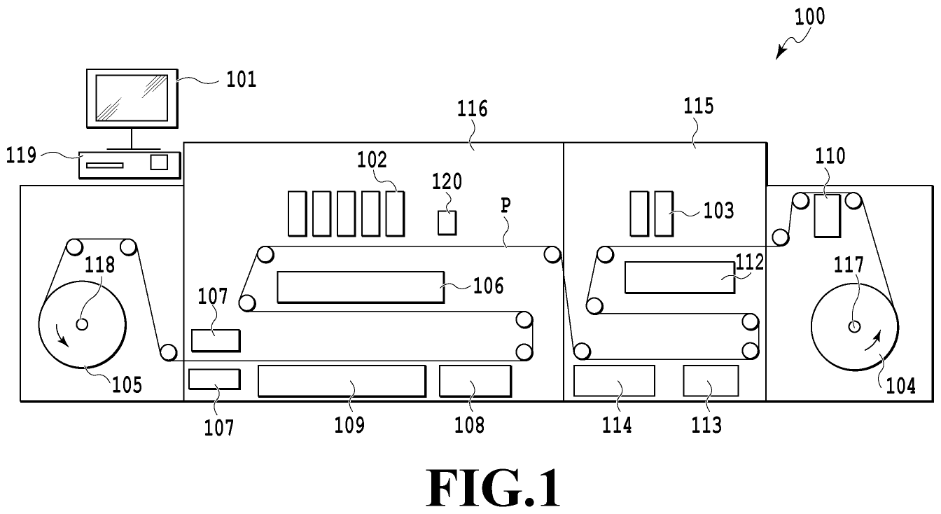

FIG. 1 is a diagram showing a configuration example of a printing system according to the present embodiment. A printing system 100 includes a sheet feed device 104 sending out roll sheet P, a first printing apparatus 115 performing printing using spot color ink, a second printing apparatus 116 performing printing using basic color inks of CMYK, a winding device 105 winding the roll sheet P, a UI panel 101, and a control PC 119.

The sheet feed device 104 is a mechanism configured to supply the roll sheet P to the first printing apparatus 115 and the second printing apparatus 116. The sheet feed device 104 rotates the sheet tube of the roll sheet P around a rotation axis 117 and sends out the roll sheet P wound around the sheet tube to the printing apparatus at a predetermined speed via a plurality of rollers (conveyance roller, sheet feed roller and the like). The winding device 105 is a mechanism configured to wind the roll sheet P discharged from the printing apparatus around the sheet tube into the form of a roll. The winding device 105 winds the roll sheet P at a predetermined speed, which is conveyed, via a plurality of rollers (for example, conveyance roller, discharge roller and the like) and holds the roll sheet P around the sheet tube of a rotation axis 118 as a product 111.

The roll sheet P is set by being run from the sheet feed device 104 to the winding device 105 before printing starts. Specifically, first, the front end of the roll sheet P is run over a skew correction device 110. Next, the roll sheet P is run under line heads 103 of the first printing apparatus 115. Next, the roll sheet P is run under a drying device 112 and then run over cooling devices 113 and 114. Next, the roll sheet P is run under a mark detection device (mark sensor) 120, line heads 102, and a drying device 106 of the second printing apparatus 116 in this order and further, run over cooling devices 108 and 109.

Then, the roll sheet P is run between connected scanner devices 107 and wound around the winding device 105. After running the roll sheet P through the inside of the first printing apparatus 115 and the second printing apparatus 116 as described above, a user inputs a print job to the control PC 119. After inputting the print job, the user starts printing by pressing down a print start button on the UI panel 101.

### Function Configuration of Control PC

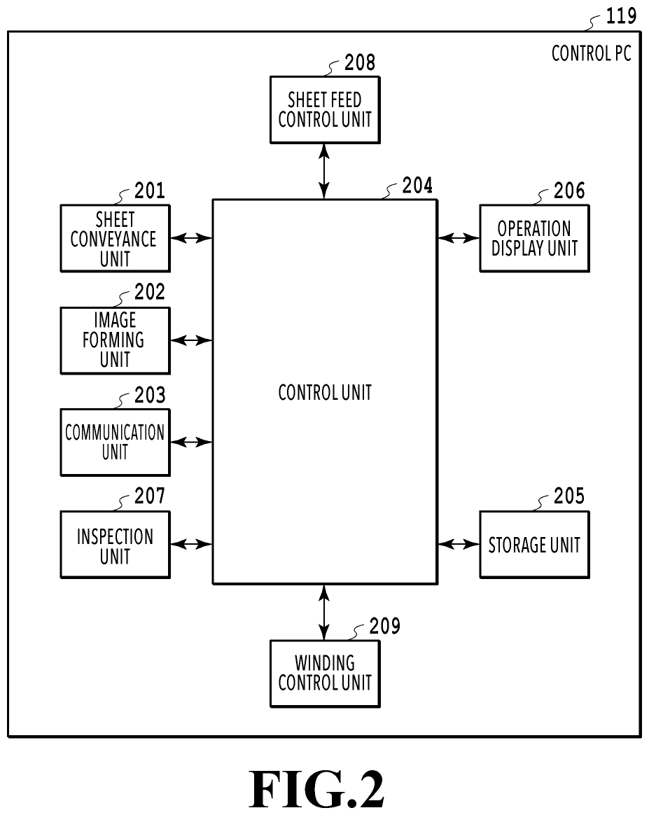

Next, the function configuration (software configuration) of the control PC 119 according to the present embodiment is explained with reference to the function block shown in FIG. 2. The control PC 119 has each function unit of a sheet conveyance unit 201, an image forming unit 202, a communication unit 203, a control unit 204, a storage unit 205, an operation display unit 206, an inspection unit 207, a sheet feed control unit 208, and a winding control unit 209.

The sheet conveyance unit 201 conveys the roll sheet P sent out from the sheet feed device 104 to the first printing apparatus 115 and the second printing apparatus 116 and further conveys the roll sheet P having passed through both the printing apparatuses to the winding device 105 by driving a plurality of rollers. The image forming unit 202 forms an image on the roll sheet P based on the image data relating to the input print job by using the first printing apparatus 115 and the second printing apparatus 116. The communication unit 203 performs transmission and reception of various pieces of data with an external device (for example, personal computer) connected to a communication network, such as LAN and WAN. The control unit 204 is in charge of comprehensive control of the entire printing system 100 by a CPU and a RAM, not shown schematically. That is, by the CPU obtaining system programs, processing programs and the like from the storage unit 205 and loading them onto the RAM, and then executing them, each function unit shown in FIG. 2 is implemented. The storage unit 205 stores various programs including system programs and processing programs and various pieces of data necessary for the execution of these programs in a nonvolatile semiconductor memory (so-called flash memory), an HDD or the like, not shown schematically. The operation display unit 206 displays various pieces of information on the UI panel 101 including, for example, a touch panel-attached liquid crystal display, receives a user operation, outputs an operation signal to the control unit 204, and so on. The user operation includes, for example, the setting of partition information in a case where a print job is input, and the like. The partition information is information indicating the insertion position of a partition page that is inserted in advance in a case where printed roll sheet (product) P′ needs to be delivered by being classified into a plurality of volumes.

### Operation Outline of Printing System

Next, a flow of the operation in a case where the printing system 100 performs print processing for the roll sheet P is explained. Prior to the start of print processing, a user creates a print job in an external information processing apparatus and transmits the print job to the printing system 100 via a communication network. The print job includes printing-target image data and printing setting information predefining printing conditions and the like of the image data. The printing setting information includes information necessary for the generation of printing data, such as the number of copies to be printed, the color adjustment, the partition page, and the correction of sheet reduction/enlargement, and information necessary for the control of the printing apparatus, such as the conveyance speed and the drying temperature.

The control unit 204 generates spot color printing data and basic color printing data based on the received print job and causes the image forming unit 202 to perform print processing. Then, the control unit 204 also causes the image forming unit 202 to perform printing of a timing mark in printing the spot color printing data. Further, the control unit 204 determines the timing to start printing of the basic color printing data based on a detection signal of the timing mark from the mark sensor 120.

The inspection unit 207 inspects the printing apparatus for the occurrence of a printing failure, such as an ink ejection failure. As the inspection method, there are a variety of methods, such as an inspection method of analyzing a read image obtained by reading the roll sheet P, which is a product, or the roll sheet P on which an inspection pattern is printed with a camera or scanner, and a method of monitoring the ejection situation from nozzles.

### Control Flow

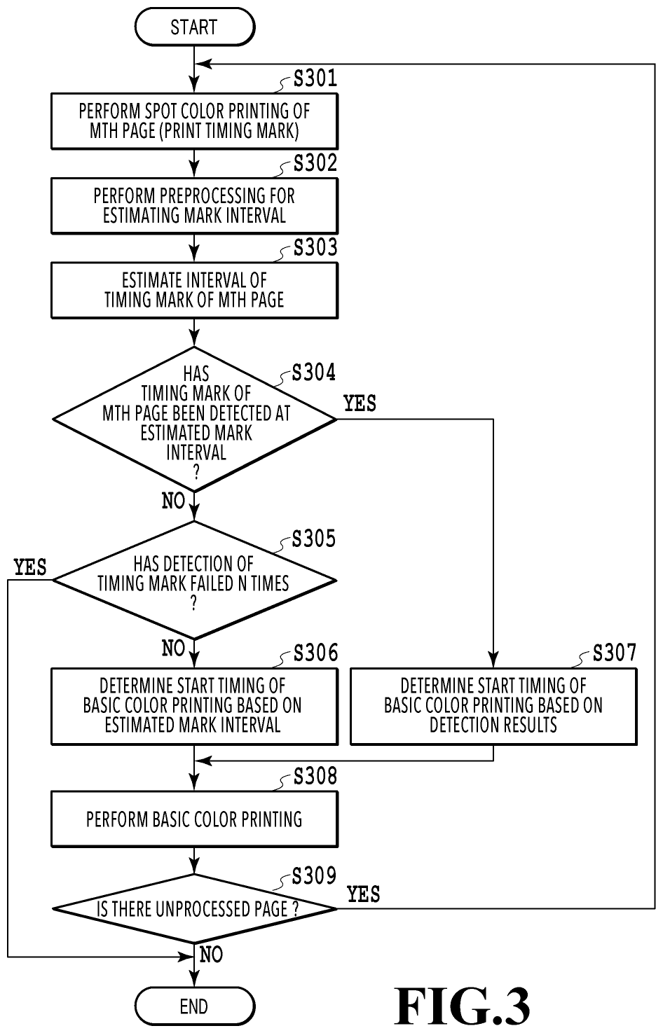

Next, with reference to the flowchart shown in FIG. 3, a flow of printing control in the printing system 100 according to the present embodiment is explained. The following flow shows a flow of a series of processing until a product of one page is completed. Actually, each piece of processing corresponding to a plurality of pages is performed in parallel at the same time, such as that basic color printing for a certain page is performed while spot color printing for another page is performed. In the following explanation, a symbol “S” means a step.

First, at S301, the image forming unit 202 performs print processing in the first printing apparatus 115, which is in accordance with the spot color printing data of the Mth page that is the processing target among the pages designated in the print job, based on the instructions from the control unit 204. In this case, printing of the timing mark for correctly adjusting the position of the plane of the spot color printing in the Mth page and the position of the plane of the basic color printing is also performed in the first printing apparatus 115. The spot colors refer to the ink colors of red, orange, green, violet and the like other than the basic colors of CMYK.

At S302, the control unit 204 performs reset processing (processing to set the number of pulses to “0”) of the pulse signal by a pulse generator, not shown schematically, as preprocessing for estimating the interval of the timing marks at S303. The contents of the preprocessing depend on the estimation method of the interval of the timing marks. For example, in a case where the interval of the timing marks is estimated by the count time (elapse of time) of the timer in place of the number of pulses of the pulse signal, it is sufficient to perform the reset processing of the timer for time measurement as preprocessing.

At S303, the control unit 204 estimates the interval (in the following, described as “mark interval”) between the timing mark of the Mth page and the timing mark of the (M−1)th page, which is one page before, based on the number of pulses of the pulse signal. For example, it is assumed that the current processing-target page is the third page (M=3). In this case, the number of pulses at this point in time of the pulse signal having been reset in printing the timing mark of the second page (M=2) represents the interval (corresponding to the conveyance amount of the roll sheet P) until the timing mark of the third page is printed. It is assumed that the conveyance speed of the roll sheet P is constant throughout the print job. In this manner, the mark interval between pages is estimated. In a case where the mark interval is estimated by the elapse of time, it is possible to perform the estimation by obtaining the count time of the timer from the point in time of printing of the timing mark of the (M−1)th page until the point in time of printing of the timing mark of the Mth page. Information on the estimated mark interval is stored in the RAM within the control unit 204.

At S304, the control unit 204 determines whether the timing mark of the Mth page has been detected by the mark sensor 120 within the second printing apparatus 116 based on the mark interval estimated at S303. In the present embodiment, the timing mark is formed on the roll sheet P by the first printing apparatus 115 that performs spot color printing performing printing by using the spot color inks. Consequently, the mark sensor 120 is used as a colorimetry sensor configured to measure the color of the roll sheet P and in a case where the color of the spot ink, not the background color of the roll sheet P, is measured at the timing indicated by the mark interval estimated at S303, it is determined that the detection of the timing mark has succeeded. In this case, a margin that takes into consideration the expansion and contraction characteristics and the like of the roll sheet P that is used is calculated based on the printing setting of the print job and provided to the timing indicated by the mark interval. To what extent the margin is provided is arbitrary, but it is general that the margin is about the supposed timing #1%. Then, the control unit 204 allocates the processing to be performed next in accordance with the determination results. Specifically, in a case where determination results indicate a detection failure, S305 is performed next and in a case where the determination results indicate a detection success, S307 is performed next.

At S305, the control unit 204 allocates the processing to be performed next in accordance with whether the number of times of detection failure of the timing mark has reached a threshold value N. As the value of the threshold value N, “2” or “3” is supposed. In a case where the number of times of detection failure is N, the control unit 204 regards the apparatus as abnormal and terminates the print processing. In a case where the number of times of detection failure is less than N, the control unit 204 performs S306 next. Here, whether or not the apparatus is abnormal is determined by the cumulative number of times of detection failure, but it may also be possible to determine that the apparatus is abnormal in a case where, for example, the detection fails N consecutive times.

At S306, the control unit 204 determines the start timing of the basic color printing based on the mark interval estimated at S303. For example, it is assumed that the roll sheet P is conveyed at a speed of 30 m/min and it is possible to form a plane (image) of the basic color printing at an appropriate position in a case where the basic color printing is started after 0.3 sec from the detection of the timing mark (that is, in a case where the roll sheet P is conveyed 15 cm after detection). In this case, predicted detection timing is found from the estimated mark interval and the number of pulses corresponding to the time, which is the found predicted detection timing+0.3 sec, is determined as the start timing of the basic color printing. Then, the control unit 204 gives instructions to perform printing to the image forming unit 202 so that the basic color printing is performed at the start timing thus determined.

At S307, the control unit 204 determines the start timing of the basic color printing based on the detection results of the timing mark by the mark sensor 120. The way of thinking in determining the start timing is the same as that at S306 and the conveyance amount from the point in time of the detection of the timing mark is found from the conveyance speed, and therefore, timing with which the plane of the basic color printing is formed at an appropriate position is determined. That is, in the example described above, it is sufficient to determine the number of pulses corresponding to the time, which is the actual detection time+0.3 sec, as the start timing of the basic color printing. Then, the control unit 204 gives instructions to perform printing to the image forming unit 202 so that the basic color printing is performed at the start timing thus determined.

At S308, the image forming unit 202 performs print processing in accordance with the basic color printing data of the Mth page in the second printing apparatus 116 based on the instructions from the control unit 204.

At S309, the control unit 204 determines whether or not the print processing of all the pages relating to the input print job has been completed. In a case where there is an unprocessed page, the processing returns to S301 and the processing is continued.

The above is the flow of the printing control in the printing system 100 according to the present embodiment. In a case of the present embodiment, even in a case where the detection of the timing mark fails, it is possible to determine the start timing of the basic color printing by identifying the position of the timing mark in a pseudo manner based on the estimated mark interval.

In a case where the processing-target page is the first page (M=1), the timing mark of the page ((M−1)th page), which is one page before the first page, does not exist, and therefore, it is not possible to perform the estimation (S303) of the interval of the timing marks. Because of this, the processing skips S303 and moves to the determination at S304. In a case where it is not possible to detect the timing mark of the first page, the case is handled as a case where no timing mark exists and the processing moves to the spot color color printing processing of the second page without performing the basic color printing in the second printing apparatus 116.

### Effects of the Present Embodiment

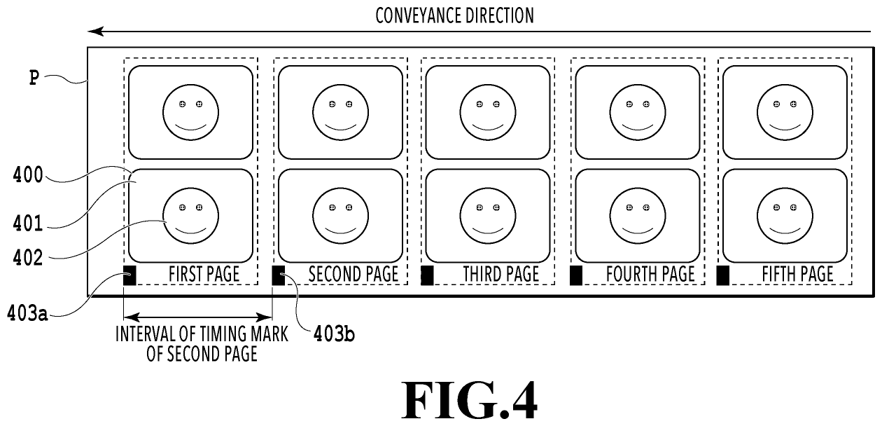

Here, the effects of the present embodiment are explained with reference to a specific example. FIG. 4 is a diagram showing one example of the roll sheet P as a product that is obtained in a case where the timing marks are formed appropriately and the detection thereof succeeds. On the printed roll sheet P shown in FIG. 4, target images each including a rounded rectangle 401 of the background, which is formed by the spot color printing, and a face 402 of the foreground, which is formed by the basic color printing, are formed for five pages without any defect. In the example in FIG. 4, for example, the timing mark interval for performing the basic color printing of the second page is the length from the position of a timing mark 403a of the first page to a timing mark 403b of the second page.

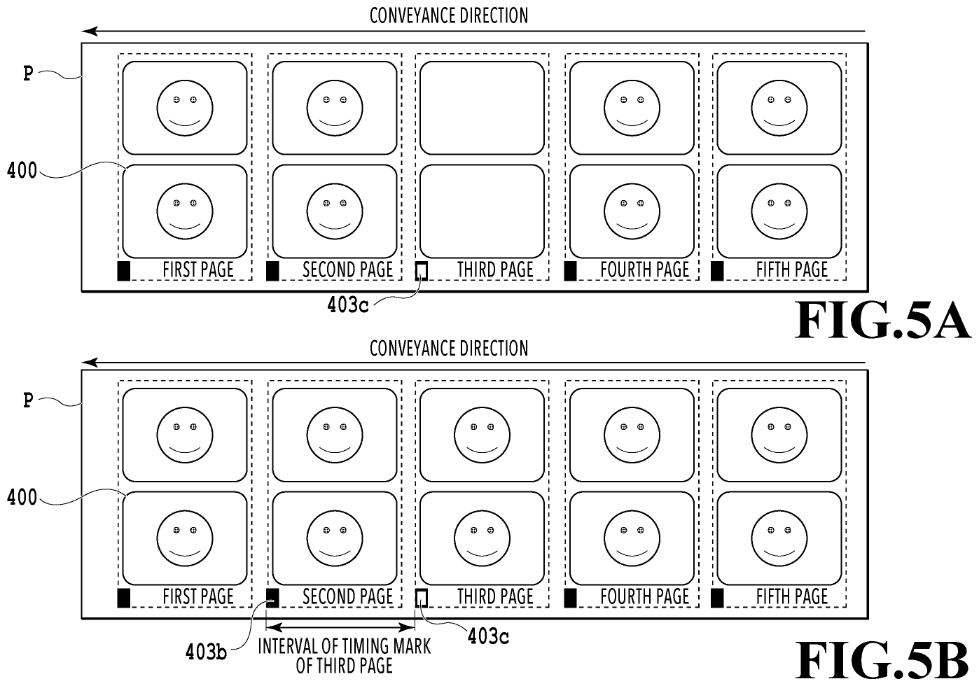

FIG. 5A and FIG. 5B are each a diagram showing printing results in a case where a defect occurs in a timing mark 403c of the third page in the specific example in FIG. 4 described above and FIG. 5A shows a case of the prior art and FIG. 5B shows a case of the present embodiment. As shown in FIG. 5A, in the prior art, as a result of that the mark sensor 120 cannot detect the timing mark 403c, the basic color printing is not performed for the third page and only each rounded rectangle 401 by the spot color printing is formed on the roll sheet P. On the other hand, as shown in FIG. 5B, in the present embodiment, even in a case where the timing mark cannot be detected, the start timing of the basic color printing is determined based on the estimated mark interval, and therefore, the target image including each rounded rectangle 401 and the face 402 is formed also for the third page. As the reason that the timing mark cannot be detected, there may be a variety of cases, such as a case where stain or dust has stuck to the mark sensor 120, in addition to a case of formation failure of the mark itself.

### Modification Example

In the present embodiment, the timing mark is formed on the roll sheet by printing, but this is not limited. For example, it may also be possible to form the timing mark on the roll sheet by a method other than printing, such as a method of pasting a seal of the same shape. Alternatively, it may also be possible to print the timing mark before the print processing by the image forming unit 202.

Further, in the present embodiment, explanation is given by taking the printing system as an example, which uses roll sheet as a printing medium, but it is also possible to apply the present embodiment to a printing system that uses, for example, a cut sheet.

As above, according to the present embodiment, even in a case where the timing mark cannot be detected successfully because of some reason, it is possible to determine the start timing of the subsequent print processing based on the estimated mark interval. As a result of that, it is possible to continue printing at the position at which the timing mark cannot be detected and printing is impossible with the prior art, and therefore, it is made possible to suppress the occurrence of an NG page.

### Second Embodiment

In the first embodiment, the aspect is explained in which in a case where the detection of the timing mark that is formed by the spot color printing in the previous stage fails in the printing system that performs the basic color printing following the spot color printing, it is made possible to perform the basic color printing in the subsequent stage based on the estimated mark interval. Next, an aspect is explained as a second embodiment in which in a case where the detection of the timing mark that is formed by the printing in the previous stage fails in a printing system that performs post printing processing following the print processing, it is made possible to perform the post printing processing in the subsequent stage based on the estimated mark interval. Explanation of the contents common to those of the first embodiment is omitted or simplified and in the following, different points are explained mainly.

### Configuration Outline of Printing System

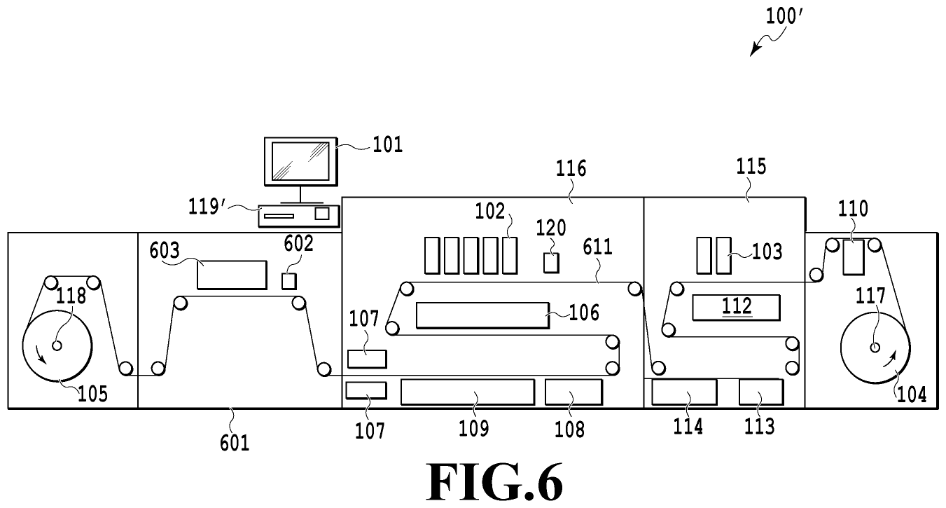

FIG. 6 is a diagram showing a configuration example of a printing system according to the present embodiment. Like the printing system 100 of the first embodiment, a printing system 100′ comprises the sheet feed device 104, the first printing apparatus 115, the second printing apparatus 116, the winding device 105, the UI panel 101, and the control PC 119, and further comprises a post printing device 601. The roll sheet P for which printing has been performed in the second printing apparatus 116 is sent out to the post printing device 601 and the roll sheet P passes through a die cut mechanism 603 after passing through a mark sensor 602 within the post printing device 601 and is wound as a product in the winding device 105.

### Function Configuration of Control PC

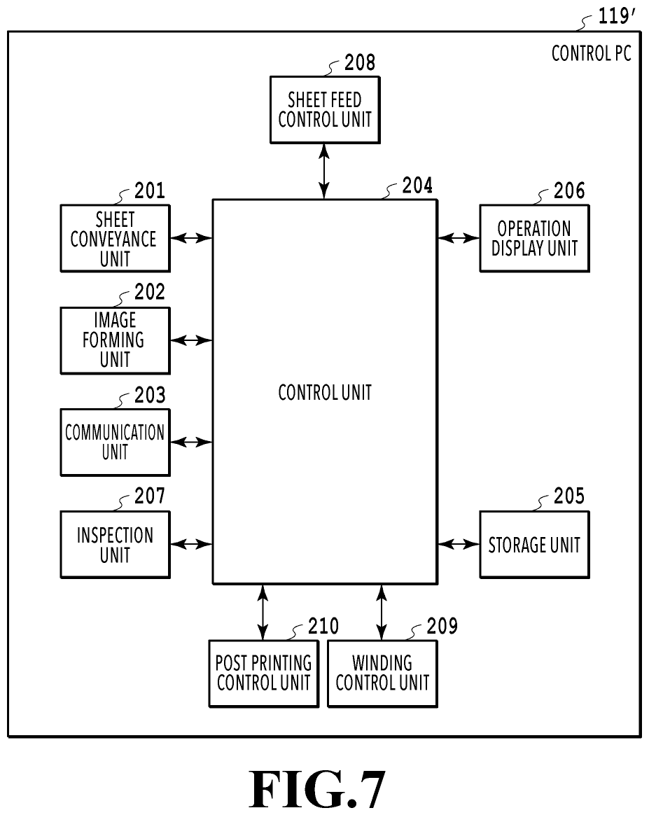

Next, the function configuration (software configuration) of a control PC 119′ according to the present embodiment is explained with reference to the function block diagram shown in FIG. 7. The control PC 119′ of the present embodiment has a modification control unit 210, in addition to the sheet conveyance unit 201, the image forming unit 202, the communication unit 203, the control unit 204, the storage unit 205, the operation display unit 206, the inspection unit 207, the sheet feed control unit 208, and the winding control unit 209. The post printing control unit 210 controls the start operation of the die cut mechanism 603 of the post printing device 601 based on the detection results of the timing mark by the mark sensor 602 or the estimated mark interval. The die cut mechanism 603 is a mechanism that performs post printing processing called “raising waste”. The raising waste refers to processing to cut out the pattern of the margin portion (called “waste”) that is not used as a seal on the upper layer side and peel the pattern and leave only the portion that is used as a seal on the lower layer side (backing sheet) in label printing using roll sheet having a two-layer structure.

### Control Flow

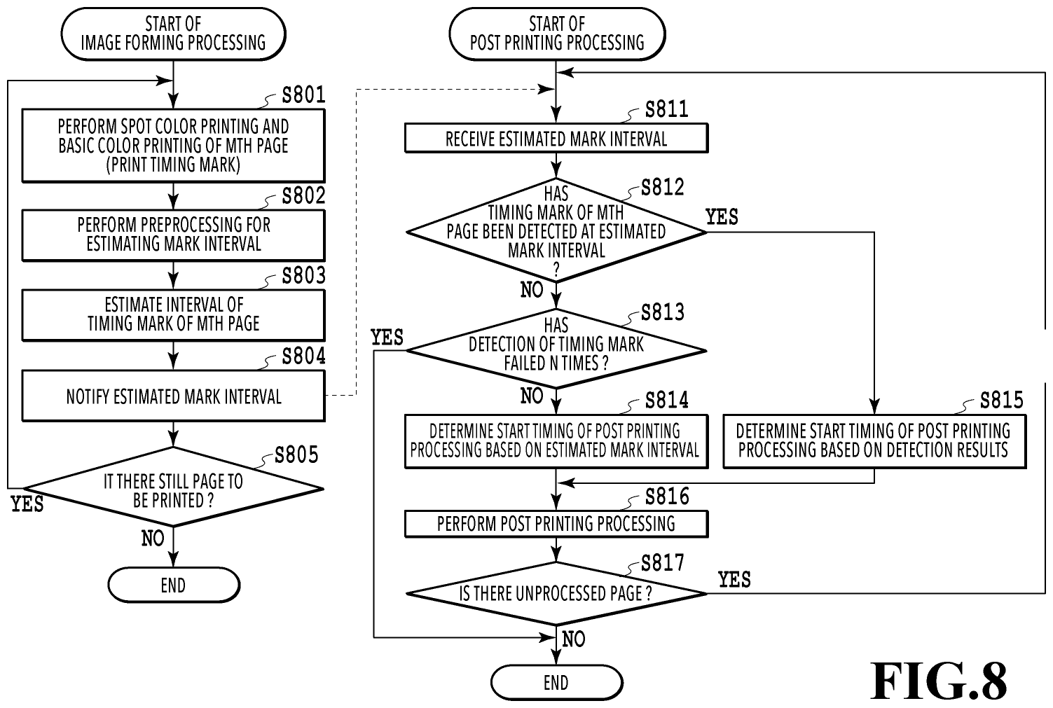

Next, with reference to the flowcharts shown in FIG. 8, a flow of control of printing and post printing in the printing system 100′ according to the present embodiment is explained. In the flowcharts in FIGS. 8, S801 to S805 in the left flowchart show a flow of processing in the printing apparatus and S811 to S817 in the right flowchart show a flow of processing in the post printing device. The flows in FIG. 8 show a flow of a series of processing until a product corresponding to one page is completed as in the flow in FIG. 3 of the first embodiment. Actually, each piece of processing is performed in parallel at the same time for products corresponding to a plurality of pages, such as a case where printing is performed for a certain page while post printing processing (here, raising waste) is performed for another page. In the following explanation, a symbol “S” means a step.

First, at S801, the image forming unit 202 performs, based on instructions from the control unit 204, print processing in the first printing apparatus 115 and the second printing apparatus 116, which is in accordance with the label printing data of the processing-target Mth page among the pages designated in the print job. In the present embodiment, it is assumed that the timing mark for performing raising waste in the Mth page is printed in the second printing apparatus 116 by using the K ink.

At S802, the control unit 204 performs the reset processing of a pulse signal by a pulse generator, not shown schematically, as preprocessing for estimating the interval of timing marks at S803. This preprocessing depends on the estimation method of the interval of the timing marks and this is the same as in the first embodiment. For example, in a case where the interval of timing marks is estimated by the elapsed time in place of the number of pulses, it is sufficient to perform reset processing of the timer for time measurement as preprocessing.

At S803, the control unit 204 estimates the interval (in the following, described as “mark interval”) between the timing mark of the Mth page and the timing mark of the (M−1)th page, one page before the Mth page, based on the number of pulses of the pulse signal at the current point in time.

At S804, the control unit 204 notifies the post printing control unit 210 of the mark interval estimated at S803. In a case of the system configuration in which label printing is performed while in cooperation with an external post printing device, it may also be possible to give the notification by wireless or wired communication, or indirectly give the notification via a server or the like.

At S805, the control unit 204 determines whether or not the print processing of all the pages relating to the input print job has been completed. In a case where there is an unprocessed page, the processing returns to S801 and the processing is continued. The processing up to this point is the flow of the processing on the side of the printing apparatus. Following the above, the flow of the processing on the side of the post printing device is explained.

At S811, the post printing control unit 210 receives the notification of the estimated mark interval from the control unit 204.

At S812, the post printing control unit 210 determines whether the timing mark of the Mth page has been detected by the mark sensor 602 within the post printing device 601 based on the estimated mark interval received at S811. As described previously, in the present embodiment, the timing mark is formed on the roll sheet P by the printing using the K ink in the second printing apparatus 116 that performs the basic color printing. Consequently, in a case where the color of the K ink is measured by the mark sensor 602 at the timing indicated by the estimated mark interval relating to the notification, it is determined that the detection of the timing mark has succeeded. In this case, the margin that takes into consideration the expansion and contraction characteristics and the like of the roll sheet P that is used is provided and this is the same as in the first embodiment. Then, the post printing control unit 210 assigns the processing to be performed next in accordance with the determination results. Specifically, in a case where the determination results indicate the detection failure, S813 is performed next and in a case where the determination results indicate the detection success, S815 is performed next.

At S813, the post printing control unit 210 assigns the processing to be performed next in accordance with whether the number of times of detection failure of the timing mark has reached the threshold value N. This processing is processing corresponding to that at S305 in the flow in FIG. 3 of the first embodiment and in a case where the number of times of detection failure is N, the apparatus is regarded as abnormal and the processing is terminated without the execution of the post printing processing. On the other hand, in a case where the number of times of detection failure is less than N, S814 is performed next. It may also be possible to determine whether the threshold value N has been reached by the consecutive number of times of detection failure in place of the cumulative number of times of detection failure and this is the same as in the first embodiment. Although not represented in the flow in FIG. 8, the post printing control unit 210 notifies the control unit 204 that the post printing processing is terminated because the number of times of detection failure of the timing mark has exceeded a predetermined number of times. Upon receipt of this notification, the control unit 204 aborts the label printing.

At S814, the post printing control unit 210 determines the start timing of raising waste based on the estimated mark interval relating to the notification. The way of thinking of the determination of the start timing is the same as that in the first embodiment and the conveyance amount from the point in time at which the timing mark would have been originally detected is found from the conveyance speed based on the estimated mark interval and the timing of cutting out a pattern is determined, with which the margin portion (waste portion) is appropriately peeled off from the backing sheet while the portion to be used as the seal is left. Then, the post printing control unit 210 gives execution instructions to the die cut mechanism 603 so that raising waste is performed at the start timing thus determined.

At S815, the post printing control unit 210 determines the start timing of raising waste based on the detection results of the timing mark by the mark sensor 602. The way of thinking in a case of the determination is the same as that at S814 and the conveyance amount from the time in point of the detection of the timing mark is found from the conveyance speed and the timing is determined, with which the margin portion (waste) is appropriately peeled off from the backing sheet while the portion to be used as the seal is left. Then, the post printing control unit 210 gives execution instructions to the die cut mechanism 603 so that raising waste is performed at the start timing thus determined.

At S816, the die cut mechanism 603 performs raising waste of the Mth page based on the instructions from the post printing control unit 210. Specifically, processing to cut out a pattern from the upper-layer side of the roll sheet P and peel off the waste portion from the backing sheet on the lower-layer side so that the image portion to be used as the target-page seal is left is performed.

At S817, the post printing control unit 210 determines whether or not the post printing processing of all the pages relating to the input print job has been completed. In a case where there is an unprocessed page, the processing returns to S811 and the processing is continued.

The above is the flow of the control of printing and post printing in the printing system 100′ according to the present embodiment. In a case of the present embodiment, even on a condition that the detection of the timing mark fails, it is possible to determine the start timing of post printing by identifying the position of the timing mark in a pseudo manner based on the estimated mark interval.

### Effects of the Present Embodiment

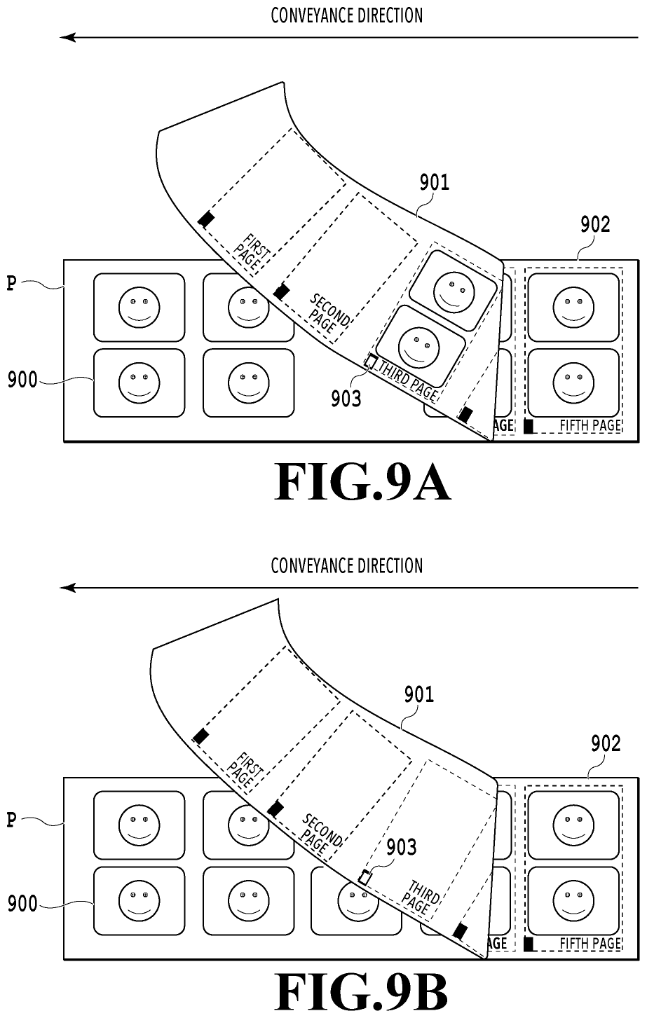

Here, effects by the present embodiment are explained with reference to a specific example. FIG. 9A and FIG. 9B are each a diagram showing post printing results in a case where a defect occurs in the timing mark of the third page and FIG. 9A shows a case of the prior art and FIG. 9B shows a case of the present embodiment. As shown in FIG. 9A, with the prior art, as a result of that the mark sensor 602 cannot detect a timing mark 903, it is not possible to cut out the seal portion for the third page, which should be originally performed, and therefore, an image to be formed 900 remains on a surface base material 901 of the roll sheet P. On the other hand, as shown in FIG. 9B, in the present embodiment, as a result of that the start timing is determined based on the estimated mark interval also for the third page, the seal portion can be cut out as a pattern also for the third page, and therefore, a backing sheet 902 for which raising waste has been performed appropriately is obtained, without the image to be formed 900 being left on the surface base material 901 of the roll sheet 9.

### Modification Example

In the present embodiment, the aspect is explained in which the estimated mark interval is utilized for the start control of the post printing processing in the post printing device 601, but it may also be possible to perform the aspect together with the first embodiment. That is, it may also be possible to use the estimated mark interval for the determination of the start timing of printing and post printing, respectively, both in a case where the mark sensor 120 of the second printing apparatus cannot detect the timing mark and in a case where the mark sensor 602 of the post printing device 601 cannot detect the timing mark.

As above, according to the present embodiment, even in a case where the timing mark cannot be detected successfully for some reason, it is possible to determine the start timing based on the estimated mark interval and continue the post printing processing in the subsequent stage. That is, it is possible to continue post printing processing also for the portion at which the timing mark cannot be detected with the prior art, and therefore, it is not possible to perform post printing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

According to the present disclosure, even in a case where the timing mark cannot be detected, it is possible to appropriately perform processing in the subsequent stage, such as printing and modification.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-207382 filed Dec. 8, 2023 which is hereby incorporated by reference wherein in its entirety.

What is claimed is:

1. A printing apparatus performing printing while conveying a printing medium, the printing apparatus comprising:
a detection unit configured to detect a mark on the printing medium for determining start timing to perform the printing or start timing to perform post printing of the printing;
a determination unit configured to determine whether or not the detection unit has succeeded in detecting the mark; and
a control unit configured to control start timing of the printing or the post printing, wherein
the control unit:
determines, in a case where the detection has succeeded, the start timing based on results of the detection; and
determines, in a case where the detection has failed, the start timing in accordance with a mark detected before the failure.

2. The printing apparatus according to claim 1, wherein
the printing apparatus comprises a first printing unit configured to perform first printing for the printing medium and a second printing unit configured to perform second printing for the printing medium for which the first printing has been performed.

3. The printing apparatus according to claim 2, wherein
the first printing unit prints the mark on the printing medium.

4. The printing apparatus according to claim 2, wherein
the mark is pasted to the printing medium or printed on the printing medium before the first printing.

5. The printing apparatus according to claim 2, wherein
the first printing is printing using a spot color other than a basic color and
the second printing is printing using a basic color.

6. The printing apparatus according to claim 1, wherein
the printing apparatus comprises a printing unit configured to perform printing for the printing medium and a modification unit configured to perform post printing processing as the post printing for the printing medium for which printing has been performed by the printing unit.

7. The printing apparatus according to claim 6, wherein
the printing unit prints the mark on the printing medium.

8. The printing apparatus according to claim 6, wherein
the mark is pasted to the printing medium or printed on the printing medium before printing by the printing unit.

9. The printing apparatus according to claim 6, wherein
the modification unit performs raising waste processing as the post printing processing for the printing medium for which label printing has been performed by the printing unit.

10. The printing apparatus according to claim 6, comprising:
an estimation unit configured to estimate an interval of the mark, wherein processing of the printing or the post printing is processing that is performed for each page,
the printing unit prints the mark for each page, and
the estimation unit estimates a mark interval between pages.

11. The printing apparatus according to claim 10, wherein
the estimation unit estimates the mark interval based on the number of pulses of a pulse signal, which represents a conveyance amount of the printing medium from a point in time at which a mark of the (M−1)th page is formed to a point in time at which a mark of the Mth page is formed.

12. The printing apparatus according to claim 10, wherein
the estimation unit estimates the mark interval based on a count time of a timer, which represents a conveyance amount of the printing medium from a point in time at which a mark of the (M−1)th page is formed to a point in time at which a mark of the Mth page is formed.

13. The printing apparatus according to claim 1, wherein
the control unit determines, in a case where the number of times the detection unit has failed to detect the mark is less than N, start timing of processing of the printing or the post printing in accordance with a mark detected before the failure.

14. The printing apparatus according to claim 1, wherein
the control unit aborts, in a case where the number of times the detection unit has failed to detect the mark is N or more, execution of processing of the printing or the post printing.

15. The printing apparatus according to claim 13, wherein
the N is the cumulative number of times of failure.

16. The printing apparatus according to claim 13, wherein
the N is the consecutive number of times of failure.

17. The printing apparatus according to claim 1, wherein
the printing medium is roll sheet.

18. The printing apparatus according to claim 1, wherein
the printing medium is a cut sheet.

19. A control method of a printing apparatus performing printing while conveying a printing medium, the control method comprising:
detecting a mark on the printing medium for determining start timing to perform the printing or start timing to perform post printing of the printing;
determining whether or not detection of the mark has succeeded; and
controlling start timing of the printing or the post printing, wherein in the controlling:
in a case where the detection has succeeded, the start timing is determined based on results of the detection; and
in a case where the detection has failed, the start timing is determined in accordance with a mark detected before the failure.

20. A non-transitory computer readable storage medium storing a program for causing a computer to perform a control method of a printing system performing printing while conveying a printing medium, the control method comprising:
detecting a mark on the printing medium for determining start timing to perform the printing or start timing to perform post printing of the printing;
determining whether or not detection of the mark has succeeded; and
controlling start timing of the printing or the post printing, wherein in the controlling:
in a case where the detection has succeeded, the start timing is determined based on results of the detection; and
in a case where the detection has failed, the start timing is determined in accordance with a mark detected before the failure.

21. A printing apparatus performing printing while conveying a printing medium, the printing apparatus comprising:
a detection unit configured to detect marks on the printing medium aligned with predetermined distance in a direction of the conveying; and
a control unit configured to
control the printing or performing post printing of the printing based on results of the detection in a case where the detection unit detect the marks and
control the printing or performing post printing of the printing based on a predetermined timing.

22. The printing apparatus according to claim 21, wherein
the predetermined timing is determined based on a timing of the printing.

23. The printing apparatus according to claim 21, wherein
the predetermined timing is determined based on the predetermined distance.
